(19) United States
(12) Patent Application Publication
(10) Pub. No.: US 2003/0197940 A1
(43) Pub. Date: Oct. 23, 2003

(54) Lens cap for optical module

(76) Inventor: Nan Tsung Huang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/152,409

(22) Filed: May 20, 2002

(30) Foreign Application Priority Data
Apr. 18, 2002 (TW) 91205224

(51) Int. Cl. G02B 1/00

(52) U.S. Cl. 359/511; 359/507

(57) ABSTRACT

A lens cap (20) for an optical module includes a housing (21) and an optical lens (22). The housing includes a sidewall (23) and a top wall (24) connecting with the sidewall. The top wall has an inclined portion (241) defining a through-hole (243) therein, and the through-hole includes a window (244) and an injection void (245) connecting with window. The optical lens is made of optical plastic and is formed in the through-hole using insert-molding. The optical lens transmits and reflects light.

### BACKGROUND OF THE INVENTION

1. Field of the Invention

The present invention relates to a lens cap for an optical module, and particularly to a lens cap for an optical module such as a transceiver, an optical sub assembly, or a semiconductor laser device.

2. Related Art

The field of optical communications is developing rapidly, and optical modules having greater performance are being designed to satisfy new system needs. Since optical modules, such as laser devices, are easily affected by their environments, the major optical elements of an optical module are generally sealed in a structure such as a lens cap.

A conventional laser device is disclosed in Japanese Patent Publication No. 63-84184 (see FIG. 1). The laser device 10 includes a base 11 and a lens cap 18. The lens cap 18 includes a housing 16 and a glass plate 17. A laser diode 14 and an optical detector 15 are received in an enclosure formed by engagement of the housing 16 to the base 11. The housing 16 includes an inclined plane 12 on a top thereof, which defines an opening 13 therein for transmission of a beam of light. The glass plate 17 is attached to the housing using adhesive to cover the opening 13, and functions to transmit and reflect beams of light and to seal the enclosure. A beam of light emitted by the laser diode 14 is divided into two portions by the glass plate 17, one portion being transmitted through the opening 13 via the glass plate 17, and the other portion being reflected into the optical detector 15 by the glass plate 17, and thereby being detected.

However, since the glass plate 17 is attached to the housing 16 by adhesive, and adhesive is easily smeared, the glass plate can be contaminated by smeared adhesive and the transmittance of the glass plate can therefore be affected. Moreover, some adhesives are susceptible to losing strength under mechanical impact or in high temperature environments, which can reduce the performance of the device. Furthermore, using adhesive complicates the manufacture and makes the device more expensive.

Accordingly, an improved lens cap for an optical module is desired to overcome the above problems. A copending application with an unknown serial number filed on May 9, 2002 titled “LENS CAP FOR TRANSISTOR OUTLIE PACKAGE” with the same applicant and the same assigned, discloses some approach.

### SUMMARY OF THE INVENTION

An object of the present invention is to provide a lens cap for an optical module which can ensure stable performance of the module and is easy to manufacture and low in cost.

To achieve the above object, a lens cap for an optical module in accordance with a preferred embodiment of the present invention includes a housing and an optical lens. The housing includes a sidewall and a top wall connecting with the sidewall. The top wall has an inclined portion defining a through-hole, which includes a window and an injection void connecting with the window. The optical lens is made of optical plastic and is formed in the through-hole using insert-molding techniques. The optical lens allows transmission and reflection of a beam of light and provides a more easily manufactured lens cap.

These and additional objects, features and advantages of the present invention will become apparent after reading the following detailed description of a preferred embodiment of the invention taken in conjunction with the appended drawings.

### BRIEF DESCRIPTION OF THE DRAWINGS

FIG. 1 is a partly cross-sectional view of a conventional laser device;

FIG. 2 is a perspective view of a lens cap for an optical module according to the present invention, without an optical lens;

FIG. 3 is a perspective view of the lens cap of FIG. 2, with the optical lens;

FIG. 4 is a top view of the lens cap of FIG. 3; and

FIG. 5 is a cross-sectional view of the lens cap of FIG. 3, taken along line V-V of FIG. 4.

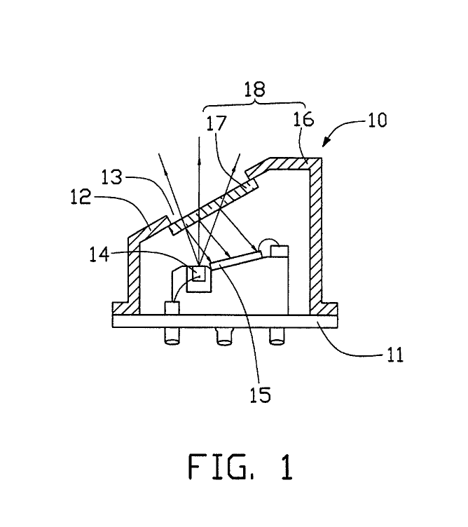

### DETAILED DESCRIPTION OF THE INVENTION

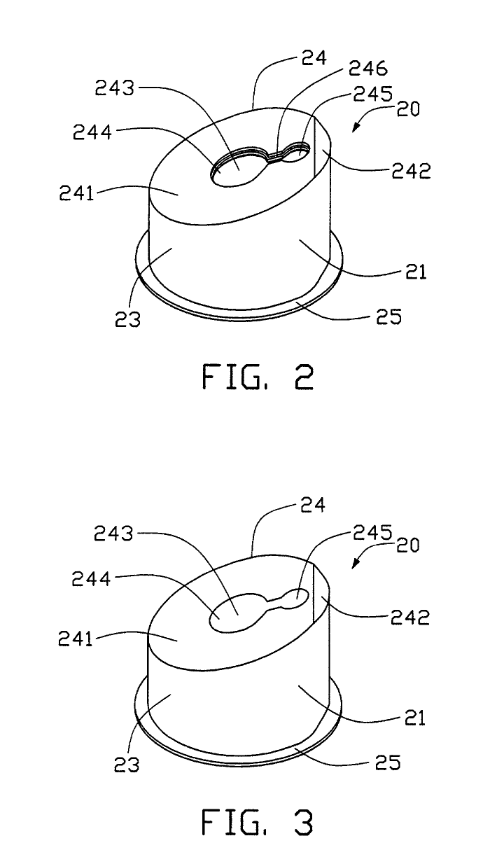

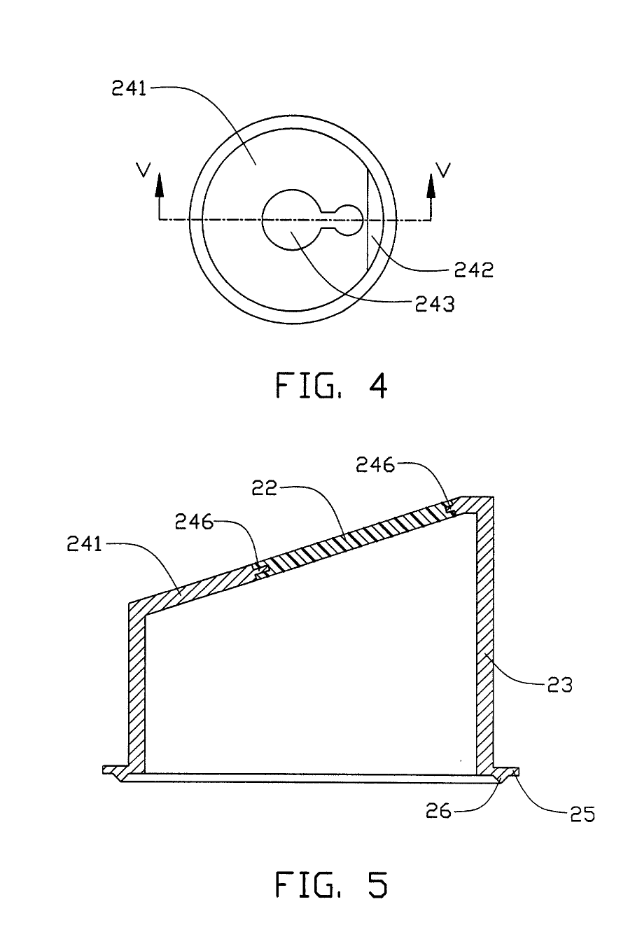

Referring to FIGS. 2-5, a lens cap 20 for an optical module in accordance with a preferred embodiment of the present invention includes a housing 21 and an optical lens 22. The housing may be of a metallic material, or may be made of another suitable material.

The housing 21 includes a cylindrical sidewall 23 and a top wall 24 connecting with the sidewall 23. An annular flange 25 extends outward from a bottom of the sidewall 23, and an annular boss 26 protrudes downwardly from the flange 25. The flange 25 and the boss 26 help seal the lens cap to a base (not shown) on which optical elements (not shown), such as a laser diode and an optical detector, are mounted. The top wall 24 includes an inclined portion 241 and a horizontal portion 242 connecting with the inclined portion 241. A through-hole 243 is defined in the inclined portion 241 and includes a window 244 for transmitting a beam of light therethrough and an injection void 245 connecting with the window 244. The drawings show the injection void 245 penetrating all the way through the inclined portion 241, but it may also be a recess in the inclined portion 241. A holding portion 246 is formed on an edge of the through-hole 243, protruding into the through-hole 243.

The optical lens 22 is insert-molded into the through-hole 243. The optical lens 22 is made of an optical plastic which transmits and reflects light. The housing 21 is placed in a mold (not shown) and melted optical plastic is injected into the mold at the injection void 245 of the housing 21. The melted optical plastic fills the injection void 245 and flows from the injection void 245 into the window 244, filling the window 244. After the optical plastic has been cooled and cured, the mold is opened and the housing 21 with newly formed optical lens 22 is extracted. The shape of the optical lens 22 matches that of the through-hole 243 and is secured in the through-hole 243 by the holding portion 246. The optical lens 22 is designed so that when a beam of light is emitted from the optical elements, one portion of the light is transmitted through the optical lens 22, and the other portion is reflected by the optical lens 22.

An anti-reflective film can be deposited on the surfaces of the optical lens 22 to increase the transmittance of the optical lens 22.

Using the insert-molding method, the optical lens 22 can be securely formed in the housing 21 without using adhesives. Therefore, the lens cap 20 provides dependable protection from impact for optical components mounted within, and is less affected by temperature than a lens cap constructed with certain adhesives. The optical lens 22 of the present invention achieves satisfactory performance using less labor during manufacturing, and at lower cost.

Although the present invention has been described with reference to a specific embodiment thereof, the description is illustrative and is not to be construed as limiting the invention. Various modifications to the present invention may be made to the preferred embodiment by those skilled in the art without departing from the true spirit and scope of the invention as defined by the appended claims.

I claim:

1. A lens cap for an optical module, comprising:
a housing including a top wall, the top wall having an inclined portion defining a through-hole therein, the through-hole having a window; and
an optical lens made of an optical plastic and formed in the window using insert-molding for transmission and reflection of a beam of light.

2. The lens cap as claimed in claim 1, wherein the top wall further defines an injection void connecting with the window therein.

3. The lens cap as claimed in claim 2, wherein the injection void is one portion of the through-hole.

4. The lens cap as claimed in claim 2, wherein the injection void is a recess.

5. The lens cap as claimed in claim 1, wherein an edge of the through-hole forms a holding portion for securing the optical lens in the through-hole.

6. The lens cap as claimed in claim 5, wherein the holding portion is in the shape of a ridge and protrudes into the through-hole.

7. The lens cap as claimed in claim 1, wherein the housing further includes a sidewall connecting with the top wall and retaining means extending from a bottom of the sidewall for helping seal the housing to a base on which optical elements have been mounted.

8. The lens cap as claimed in claim 7, wherein the retaining means includes a flange extending outwardly from the bottom of the sidewall, and a boss protruding downwardly from the flange.

9. A lens cap for an optical module, comprising:
a housing including a sidewall and a top wall connecting with the sidewall, the top wall having an inclined portion defining a window extending through the top wall and an entry for injecting molten optical material, the entry connecting with the window; and
an optical lens made of optical plastic and formed in the window using insert-molding, the optical lens being for transmission and reflection of a beam of light.

10. The lens cap as claimed in claim 9, wherein an edge of the window forms a holding portion for securing the optical lens in window.

11. The lens cap as claimed in claim 10, wherein the holding portion is a ridge protruding from the edge.

12. The lens cap as claimed in claim 9, wherein the sidewall includes retaining means extending from a bottom of the sidewall for helping the housing to seal with a base on which optical elements are mounted.

13. A lens cap assembly comprising:
a top wall with an inclined portion thereof;
a through hole formed in said inclined portion;
a lens injection molded in said through hole;
a laser diode spatially located under said lens; and
an optical detector located spatially located under the lens and beside said laser diode; wherein
light derived from the laser hits an inclined underside of the lens with some portion penetrating therethrough and some other portion being reflected therefrom toward the detector.

14. The assembly as claimed in claim 13, wherein a thickness of said lens is generally equal to that of the inclined portion.

15. The assembly as claimed in claim 13, wherein a top surface of the lens is generally flush with that of the inclined portion.

16. The assembly as claimed in claim 13, wherein an undersurface of the lens is generally flush with that of the inclined portion.
